(19) United States
(12) Patent Application Publication
(10) Pub. No.: US 2006/0003744 A1
(43) Pub. Date: Jan. 5, 2006

(54) Method for providing a cellular phone or a portable terminal with news or other information

(75) Inventors: Hiroshi Kaneko, Tokyo (JP); Mutsuko Oba, Tokyo (JP); Kimitoshi Yamada, Tokyo (JP)

Correspondence Address: BROMBERG & SUNSTEIN LLP, 125 SUMMER STREET, BOSTON, MA, 02110-1618, US

(73) Assignee: Kinesics, Inc.

(21) Appl. No.: 11/171,684

(22) Filed: Jun. 30, 2005

(30) Foreign Application Priority Data
Jun. 30, 2004 (JP) 2004-193191

(51) Int. Cl. H04M 11/00

(52) U.S. Cl. 455/412.2; 455/414.1

(57) ABSTRACT

In the conventional method for providing users with news or other information, there is a system in which information represented by characters or voices is sent to the users. However, if the users do not hear all of the information that is transformed into the voice-data or character-data, they cannot understand it. Thus, they cannot easily, or quickly, get their favorite news or other information. The purpose of this invention is to provide a method for easily, anytime, quickly, and anywhere, providing one's favorite news or other information by using communication networks which connect cellular phones or portable terminals to communicating stations.

### TECHNICAL FIELD

This invention relates to a method for providing users of cellular phones or portable terminals with news or other information. Especially, it relates to a method for providing information expressed by cartoons or animations.

### BACKGROUND OF INVENTION

In the present society, to change its culture, the amount of news or other information about politics, economics, society, sports, culture, and public entertainments, has become abundant. The demands for easily, anytime, quickly, and anywhere, getting one's favorite news or other information have increased.

In contrast, there are many kinds of mass media to provide news or other information. Newspapers, radio, television, personal computers using communication networks, cellular phones, and portable terminals are used to provide the news or other information.

In these mass media, especially the cellular phones and the portable terminals are widely put to practical use. If the news or other information is provided by using the cellular phones and the portable terminals, the users of them can easily, anytime, and anywhere, get their favorite news or other information.

However, when the users get the news or other information by the cellular phones and the portable terminals, since the news or other information is communicated by characters, they must read a large quantity of the small characters. Thus, it has been difficult for them to easily, anytime, and anywhere, get their favorite news or other information.

To solve this problem, Japanese Patent Laid-open Publication No. 2002-215534 teaches a method for providing users with news or other information so that they can easily utilize it.

In this method, a server has the following means:

an accessing means to get information at the communicating time which was beforehand designated by users through the Internet, wherein the information belongs to at least one category, such as news or other information, which was selected by the user, and is selected from the source of the information which varies from hour to hour,

a generating means to generate voice-data files which are transformed from the information composed of characters with the MP3 format, and

a communicating means to E-mail the voice-data files to the users at the predetermined communicating time.

The users can receive the voice-data files through information terminals, and can play them by a player, such as watches having a function of playing the voices, or portable music players.

Further, the voice-data files are communicated to an automatic ticket gate, and then they are forwarded to the information terminals of the users.

### SUMMARY OF INVENTION

In a method for providing users with news or other information, if the users do not hear all of the information that is transformed into the voice-data files, they cannot understand it. Thus, they cannot easily and quickly get their favorite news or other information.

The purpose of this invention is to easily, anytime, quickly, and anywhere, provide a method for providing one's favorite news or other information by using communication networks which connect the cellular phones or the portable terminals to communicating stations.

To solve the above problem, the present invention has the following features:

A method for providing news or other information by using communication networks which connect cellular phones or portable terminals to communicating stations, comprising:

(1) a preparing step to prepare data of one or more cartoons which are transformed from the latest news or other information and obtained at each predetermined interval,

(2) an uploading step to upload said data to a server which is connected to the communication networks, and

(3) a communicating step to communicate said data uploaded into said server to the users of the cellular phones or the portable terminals based on demands from the users.

This method allows the users of the cellular phones or the portable terminals to access the server through the communication networks, and to receive the news or other information that is represented by one or more cartoons. Unlike the news or other information that is communicated only by characters or voices, the cartoons can immediately communicate various kinds of information to the users. For example, when a person is portrayed in a cartoon, the emotions of the person, such as anger, delight, sorrow, or surprise, can be inferred from the facial expression of the person. Thus, the cartoons can communicate the information by stimulating the sensitivity of the person who wants to get the news or other information.

Since the information represented by the cartoons has a far greater quantity of information than the information which is communicated only by characters or voices, the users of the cellular phones or the portable terminals can easily and quickly get the news or other information. Further, since cellular phones and portable terminals are portable, they can easily, anytime, and anywhere get the news or other information that is represented by one or more cartoons.

The present invention also has the following features:

A method for providing news or other information by using communication networks which connect cellular phones or portable terminals to communicating stations, comprising:

(1) a preparing step to prepare data of one or more cartoons which are transformed from the latest news or other information and obtained at every predetermined interval,

(2) an uploading step to upload said data to a server which is connected to the communication networks based on a classified category, and

(3) a communicating step to communicate said data uploaded into said server to the users of the cellular phones or the portable terminals based on their demands for designating the category.

This method allows the users of the cellular phones or the portable terminals to get the news or other information that is classified into categories and designated.

The present invention also has the following features:

A method for providing news or other information according to either claim 1 or 2 by using communication networks which connect the cellular phones or the portable terminals to the communicating stations, wherein said data is composed of the data of animations instead of the data of the one or more cartoons.

This method allows the users of the cellular phones or the portable terminals to easily and immediately get more information from the animations than from the cartoons.

The present invention also has the following features:

A method for providing news or other information according to any of claims 1, 2, and 3 by using a communication network which connects the cellular phones or the portable terminals to the communicating stations, wherein said data further contains the data of voices.

This method allows the users of the cellular phones or the portable terminals to easily and immediately get more information, because in addition to the data of the cartoons and the animation, the data of the voices is added.

The present invention also has the following features:

A method for providing news or other information according to any of claims 1-4 by using communication networks which connect the cellular phones or the portable terminals to the communicating stations, wherein said communicating step to communicate said data uploaded into said server to the users of the cellular phones or the portable terminals is composed of a step to communicate said data by E-mail.

This method allows the users of the cellular phones or the portable terminals to get the information at the predetermined time that is reserved by the users, or to get it at the same time or at the same intervals every day.

### EFFECTS OF INVENTION

This method allows the users of the cellular phones or the portable terminals to access the server through the communication networks, and to get the news or other information that is represented by one or more cartoons. Since the information represented by the cartoons has a far greater quantity of information than the information which is communicated only by characters or voices, the users of the cellular phones or the portable terminals can easily and quickly get the news or other information.

Further, since the cellular phones or the portable terminals are portable, the users can easily, anytime, and anywhere, get the news or other information that is represented by one or more cartoons.

This method also allows the users of the cellular phones or the portable terminals to get the news or other information that is classified into categories and designated.

This method also allows the users of the cellular phones or the portable terminals to easily and immediately get more information by the animations than by the cartoons. They can also easily and immediately get more information by the cartoons than is added by the data of voices.

Further, this method allows the users of the cellular phones or the portable terminals to get the information at the predetermined time that is reserved by the users, or to get it at the same time or at the same intervals every day.

### BRIEF DESCRIPTIONS OF THE DRAWINGS

FIG. 1 shows a block diagram that illustrates a method for providing news or information according to this invention.

FIG. 2 shows a block diagram that illustrates an embodiment of a server for communicating information.

### PREFERRED EMBODIMENTS OF THE INVENTION

Below, the preferred embodiments of the invention of the method for providing the users of cellular phones or portable terminals with news or other information are explained in detail.

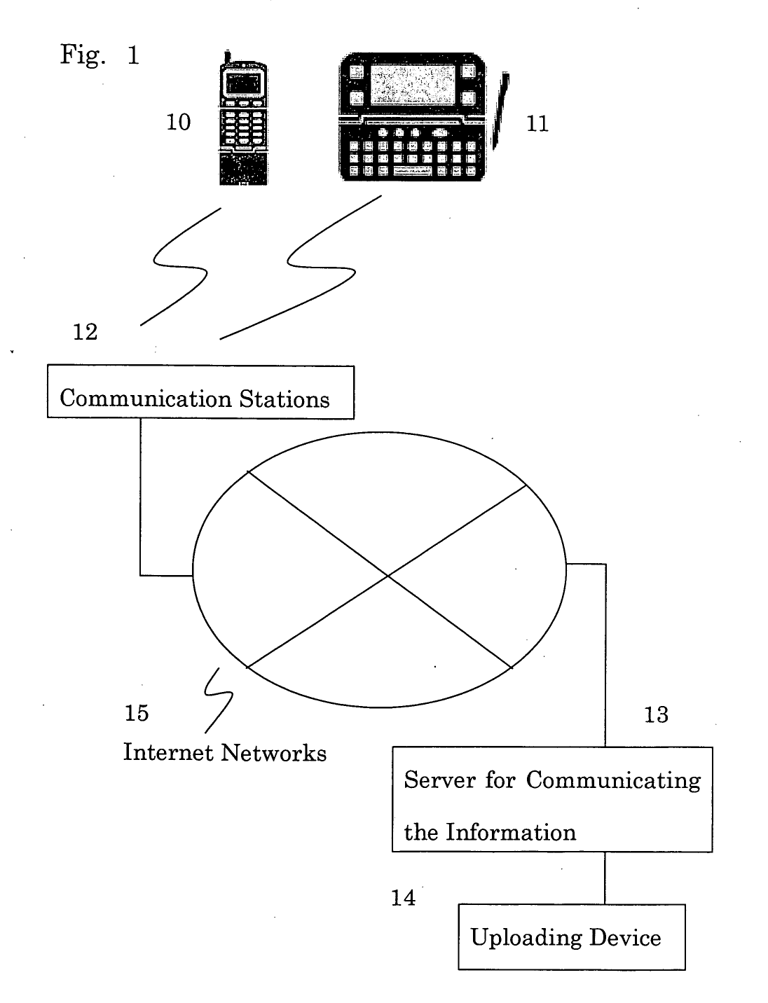

FIG. 1 shows a block diagram expressing the method for providing the news or other information according to the invention.

FIG. 1 illustrates the server 13 for communicating the information, and the uploading device 14 to upload data files of the cartoons, the animations, and the voices.

FIG. 1 also illustrates the cellular phones 10 and the portable terminals 11, i.e., portable information terminals, such as laptop personal computers and PDAs (Personal Digital Assistants). These are connected to the communicating stations 12 by a radio circuit. The communicating stations are further connected to the server 13 for communicating the information through the communication network 15.

Below, the method for providing the news or other information according to the present invention is explained.

A provider for providing the news or other information prepares the data files of the pictures that are composed of one or more cartoons made by a staff of specialists of the cartoons and that are compressed by means of compressor software. Then the data files of the pictures are uploaded to the server by using the uploading device 14. The data files of the pictures of the animations or those of the voices that are related to the data files of the pictures of the one or more cartoons may be uploaded to the server instead of only one or more cartoons. Further, these data files may be uploaded to the server after being classified in several categories, such as politics, economics, society, sports, culture, and public entertainments.

First, the users of cellular phones or portable terminals access the server 13 through the communicating stations 12 and the communication networks 15 by means of the cellular phones 10 or the portable terminals 11, and then register themselves as customers.

When the users of the cellular phones or the portable terminals register themselves as customers, they may also register E-mail addresses.

It is possible to make use of existing communication services for cellular phones. For example, service systems that use the data of the users registered in the existing communication services which in turn use the number of the cellular phone as key data are also available. The users can make use of the-systems by just uploading the passwords that are already registered.

In these systems, it is possible for them to be supported by collecting payments made by the providers of the existing communication services on behalf of the provider of this system.

After the registration, the users can designate their favorite categories of information. The server for communicating the information selects the information that is designated, such as data files of pictures, and communicates them to the users of the cellular phones or the portable terminals. If the users register themselves as customers at the first access, it is possible to design the system so that they may omit registering themselves again.

In addition to the data files of the pictures of the cartoons, when those of the animations or the data files of the voices that relate to them are stored in the server, the users can select their favorite data files from those data files and download them.

The users of cellular phones or portable terminals can also designate the categories of the information that are discussed above and download their favorite news or other information.

The users can get the information contained in the registered categories at the designated date and time from the server 13 for communicating the information. The categories and the date and time can be registered by the E-mail that is registered when they register themselves as customers.

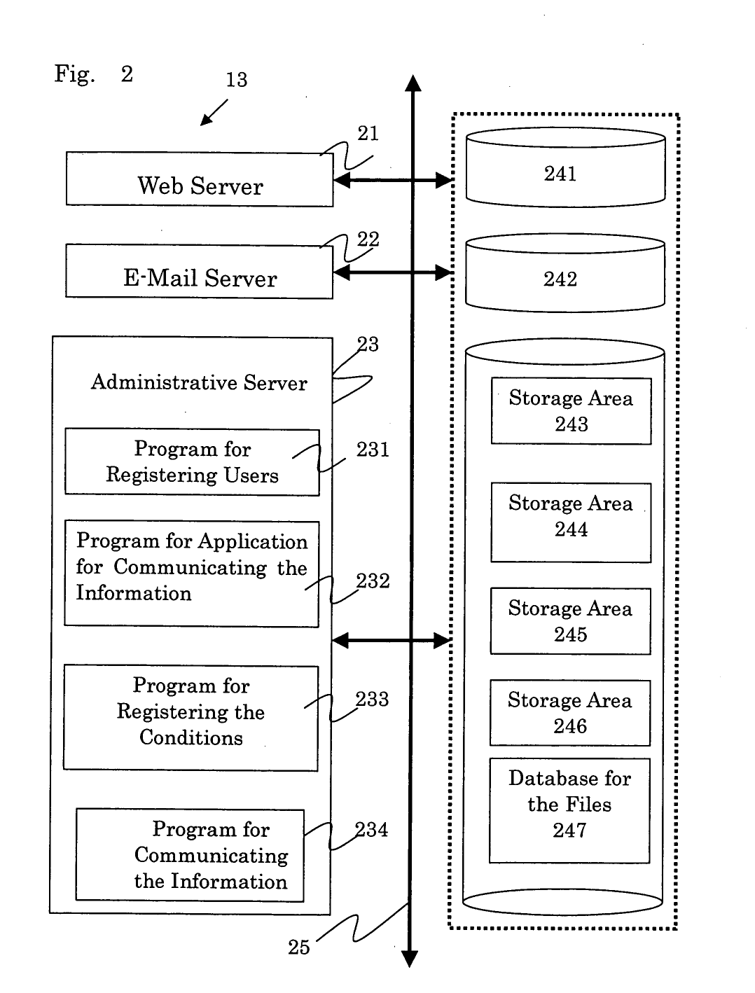

Below, the compositions of the server for communicating the information are explained based on FIG. 2

FIG. 2 shows a diagram of an embodiment of the server 13 for communicating the information. In this invention, the server 13 is not restricted to the embodiment, and other kinds of servers can be used.

The server 13 for communicating the information includes a web server 21, an E-mail server 22, an administrative server 23, a memory unit 24, and a bus 25 for connecting these devices. For example, a storage device, such as a HDD, is used as the memory unit 24. The memory unit 24 has a plurality of storage areas 241, 242, 243, . . . .

The web server 21, which is disposed in the server 13 for communicating the information, can communicate the information to the cellular phones 10 or the portable terminals 11 through the communication service networks 15, and administer the homepage for registering the users as customers. The data related to the homepage is stored in the storage area 241 of the memory unit 24. When the users of the cellular phones or the portable terminals access the web server 21, it provides them with the homepage and allows them to register themselves as customers, to request an application for communicating the information, and to register the conditions for communicating the information.

The program 231 for registering the users, the program 232 for the application for communicating the information, and the program 233 for registering the conditions to communicate the information, which are all stored in the administrative server 23 and activated, deal with registering themselves as customers, with requesting an application for communicating the information, and with registering the conditions for communicating the information.

When the users register themselves as customers, their names, addresses, and E-mail addresses are registered. Then, the user IDs, i.e., the passwords for the users, are issued. These data related to the users are stored in the storage area 243 for the data related to the users, which is disposed in the memory unit 24.

The program for the application for communicating the information 232 allows the users of the cellular phones or the portable terminals to designate the information of their favorite category. The data of the application for communicating the information is stored in the storage area 244 for it.

Further, the program 233 for registering the conditions of communicating the information allows the users of the cellular phones or the portable terminals to reserve the conditions for communicating the news or other information. The data of the conditions for communicating the information is stored in the storage area 245 for it.

The administrative server 23 activates the program 234 for communicating the information. The program searches for the data that is necessary and stored in the database 247 for the files based on the data of the application for communicating the information and the data of the conditions for communicating the information. Then, the web server 21 provides the users of the cellular phones or the portable terminals with the information represented by the cartoons. The data related to the information provided by the web server 21 is stored in the storage area 246 for it.

In order to provide the users of the cellular phones or the portable terminals with the news or other information represented by the cartoons by means of the E-mail, or to receive the E-mail of inquiries from the users, the server 13 for communicating the information includes the E-mail server 22. The data received or sent by the E-mail server is stored in the storage area 242 of the memory unit 24.

1-5. (canceled)

6. A method for providing news or other information by using communication networks which connect cellular phones or portable terminals to communicating stations, comprising:
(1) a preparing step to prepare data of one or more cartoons which are transformed from the latest news or other information and obtained at predetermined intervals;
(2) an uploading step to upload the data to a server which is connected to the communication networks; and
(3) a communicating step to communicate the data uploaded into the server to users of the cellular phones or the portable terminals based on demands from the users.

7. A method for providing news or other information by using communication networks which connect cellular phones or portable terminals to communicating stations, comprising:
(1) a preparing step to prepare data of one or more cartoons which are transformed from the latest news or other information and obtained at predetermined intervals;
(2) an uploading step to upload the data to a server which is connected to the communication networks based on a classified category; and
(3) a communicating step to communicate the data uploaded into the server to users of the cellular phones or the portable terminals based on demands from the users.

8. A method according to either of claims 6 or 7, wherein the data includes data of animations instead of the data of the one or more cartoons.

9. A method according to either of claims 6 or 7, wherein the data further includes the data of voices.

10. A method according to either of claims 6 or 7, wherein the communicating step to communicate the data uploaded into the server to the users of the cellular phones or the portable terminals includes a step to communicate the data by e-mail.

11. A method for providing news or other information by using a communication network which connects a cellular phone or portable terminal to a communicating station, comprising:
(1) preparing data associated with a cartoon representing the latest news or other information and obtained at predetermined intervals;
(2) uploading the data to a server which is connected to the communication network; and
(3) communicating the data uploaded to the server to a user of the cellular phone or the portable terminal based on a demand from the user.

12. A method according to claim 11, wherein uploading the data to a server includes uploading the data to a server which is connected to the communication network based on a classified category.

13. A method according to claims 11 or 12, wherein the data includes data associated with an animation.

14. A method according to claims 11 or 12, wherein the data includes data associated with a voice.

15. A method according to claims 11 or 12, wherein communicating the data uploaded into the server includes communicating the data by e-mail.
